(19) United States
(12) Patent Application Publication
(10) Pub. No.: US 2015/0055553 A1
(43) Pub. Date: Feb. 26, 2015

(54) WIRELESS COMMUNICATION SYSTEM AND SETUP METHOD THEREFOR

(71) Applicant: MODIOTEK CO., LTD., Hsinchu (TW)

(72) Inventors: Wen-Shih Liang, Hsinchu City (TW); Fu-Kuei Hsu, Hsinchu County (TW)

(73) Assignee: MODIOTEK CO., LTD., Hsinchu (TW)

(21) Appl. No.: 14/069,577

(22) Filed: Nov. 1, 2013

(30) Foreign Application Priority Data
Aug. 22, 2013 (TW) 102130080

(51) Int. Cl. H04W 76/02; H04W 4/00

(52) U.S. Cl. CPC H04W 76/023; H04W 4/008
USPC 370/328

(57) ABSTRACT

A wireless communication system includes: a smart device, supporting at least a first wireless communication connection and a second wireless communication connection; a wireless network connecting device, supporting at least the second wireless communication connection; and a controlled device, supporting at least the first wireless communication connection and the second wireless communication connection. The controlled device has input keys whose number is less than a threshold value. After the smart device and the controlled device are paired via the first wireless communication connection, the smart device sends a connection setup related information to the controlled device via the first wireless communication connection. The controlled device is connected to the wireless network connecting device and the second wireless communication connection based on the connection setup related information.

This application claims the benefit of Taiwan application Serial No. 102130080, filed Aug. 22, 2013, the disclosure of which is incorporated by reference herein in its entirety.

### TECHNICAL FIELD

The disclosure relates in general to a wireless communication system and a setup method therefor, and more particularly to a wireless communication system and a setup method therefor which can simplify user's connection setup procedure.

### BACKGROUND

In daily life, wireless network is more and more popular. Via the wireless network, a user's hand-held device may be connected to Internet at any time, any place.

If a user wants to connect a new wireless device to the wireless network, a complicated setup procedure has to be performed by the user. This is a great challenge for users who do not have enough professional skill.

Therefore, one of the industry's targets is to simplify user manual connection setup procedure in setting up the wireless network.

### SUMMARY

The disclosure is directed to a wireless communication system and a setup method therefor, wherein a connection setup related information required by a controlled device is provided from a smart device. Therefore, when the controlled device is to be connected to the wireless communication system, a user does not have to input complicated setup information and thus user manual connection setup procedure is simplified.

According to one embodiment of the disclosure, a wireless communication system is provided. The wireless communication system includes a smart device, a wireless communication connecting device and a controlled device. The smart device supports at least a first wireless communication connection and a second wireless communication connection. The wireless communication connecting device supports at least the second wireless communication connection. The controlled device supports at least the first wireless communication connection and the second wireless communication connection. The controlled device has input keys whose number is less than a threshold value. After the smart device and the controlled device are paired via the first wireless communication connection, the smart device sends a connection setup related information to the controlled device via the first wireless communication connection. The controlled device is connected to the wireless network connecting device and the second wireless communication connection based on the connection setup related information.

According to another embodiment of the disclosure, a setup method for a wireless communication system is provided. The wireless communication system includes a smart device, a wireless communication connecting device and a controlled device. The controlled device has input keys whose number is less than a threshold value. The setup method includes: pairing the smart device and the controlled device via the first wireless communication connection; sending a connection setup related information from the smart device to the controlled device via the first wireless communication connection; and connecting the controlled device to the wireless network connecting device and the second wireless communication connection based on the connection setup related information.

### BRIEF DESCRIPTION OF THE DRAWINGS

FIG. 1 shows a wireless communication system according to an embodiment of the disclosure.

FIG. 2 shows a wireless connection setup flowchart for the wireless communication system according to the embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms are based on the description or explanation of the disclosure. Description of a common technology or a common theory in the related technical field is omitted. Further, shapes, sizes and ratios of the elements and the flow sequence are exemplary for one skilled person in the art to understand the disclosure, not to limit the disclosure.

In possible implementation, one skilled person in the art would selectively implement part or all technical features of any embodiment of the disclosure or selectively combine part or all technical features of the embodiments of the disclosure based on the disclosure.

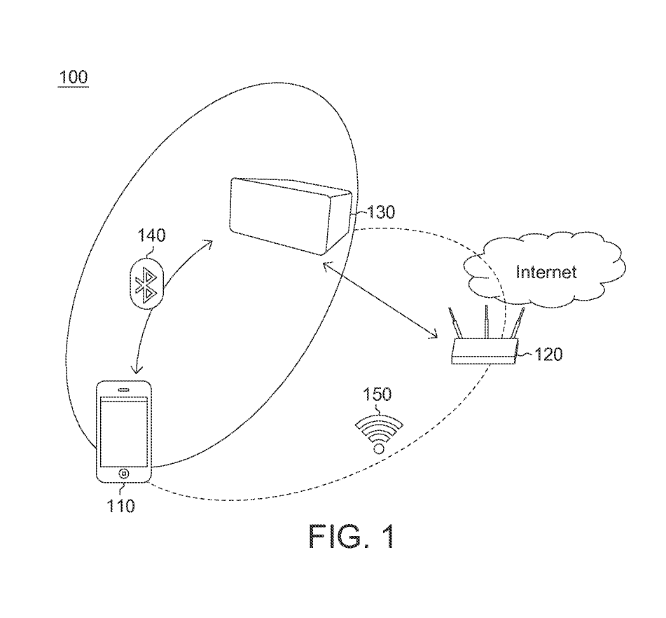

Referring to FIG. 1, a wireless communication system 100 according to an embodiment of the disclosure is shown. As shown in FIG. 1, the wireless communication system 100 includes a smart device 110, a wireless network connecting device 120 and a controlled device 130.

The smart device 110 has a user input element (for example, but not limited by, keyboards) and a display element (for example, but not limited by, a LCD screen). The smart device 110 supports at least two different wireless communication connection including a first wireless communication connection 140 and a second wireless communication connection 150. With the assistance from the smart device 110, the controlled device 130 can he connected to the second wireless communication connection 150. Besides, the smart device 110 can also manage other network devices in the current environment.

In the embodiment, the smart device 110 is, for example, a smart phone, a tablet computer, a personal computer or a notebook computer. The smart device 110 is operated in, for example but not limited by, a Windows® operation system, a Linux® operation system, an iOS® operation system, an Android® operation system or a WebOS® operation system.

The first wireless communication connection 140 is a simple pairing (i.e. in pairing, the account and the password are not needed), short transmission distance, low data transmission rate and temporary wireless communication connection. The smart device 110 and the controlled device 130 are paired and communicated with each other via the first wireless communication connection 140. Then, the connection of the smart device 110 and the controlled device 130 to the first wireless communication connection 140 is interrupted; and the smart device 110 and the controlled device 130 are connected to the second wireless communication connection 150 for communication. That is to say, after the smart device 110 sends a connection setup related information to the controlled device 130 via the first wireless communication connection 140 (when the smart device 110 and the controlled device 130 are paired), the first wireless communication connection 140 between the smart device 110 and the controlled device 130 is interrupted. The first wireless communication connection 140 is, for example, Bluetooth, NFC (Near Field Communication) or WiFi Adhoc.

Compared with the first wireless communication connection 140, the second wireless communication connection 150 is a complicated pairing (i.e. in pairing, the account and the password are required), long transmission distance, high data transmission rate and permanent wireless communication connection. In normal condition, the smart device 110 and the controlled device 130 are permanently connected to the second wireless communication connection 150 (that's why the second wireless communication connection 150 is called a “permanent” wireless communication connection), so that the smart device 110 and the controlled device 130 can transmit data with each other. In other words, in normal condition, the smart device 110 and the controlled device 130 should be connected to the second wireless communication connection 150, unless the user chooses to disconnect the smart device 110 and the controlled device 130 from the second wireless communication connection 150. The second wireless communication connection 150 is, for example, WiFi, Intel WiDi (Intel Wireless Display) connection, Miracast, Airplay, 3G/4G mobile network.

The wireless network connecting device 120 supports the second wireless communication connection 150; and the wireless network connecting device 120 can selectively support the first wireless communication connection 140. The smart device 110, the wireless network connecting device 120 and the controlled device 130 are connected to each other via the second wireless communication connection 150. Further, the smart device 110 and the controlled device 130 are connected to Internet via the wireless network connecting device 120.

The controlled device 130 also supports at least the first wireless communication connection 140 and the second wireless communication connection 150. Without the assistance from the smart device 110, the controlled device 130 can be connected to the first wireless communication connection 140. Compared with the smart device 110, the number of the input keys of the controlled device 130 is not enough for the user to complete a manual setup procedure (for example, inputting an account and a password) which is necessary for connecting the controlled device 130 to the second wireless communication connection 150. That is, the controlled device 130 has input keys whose number is less than a threshold value.

Therefore, in the embodiment, in order to facilitate the user to connect the controlled device 130 to the second wireless communication connection 150, the smart device 110 sends the connection setup related information (for example, the account and the password which is required in connecting the controlled device 130 to the second wireless communication connection 150) to the controlled device 130 via the first wireless communication connection 140; and the controlled device 130 converts the received connection setup related information.

Then, the controlled device 130 is connected to the wireless network connecting device 120 and the second wireless communication connection 150. Further, the controlled device 130 can be connected to Internet for accessing Internet data via the wireless network connecting device 120. The controlled device 130 is, for example, a network printer, a network camera, a network speaker, a network TV or a network home controller (which is used in a smart home control system).

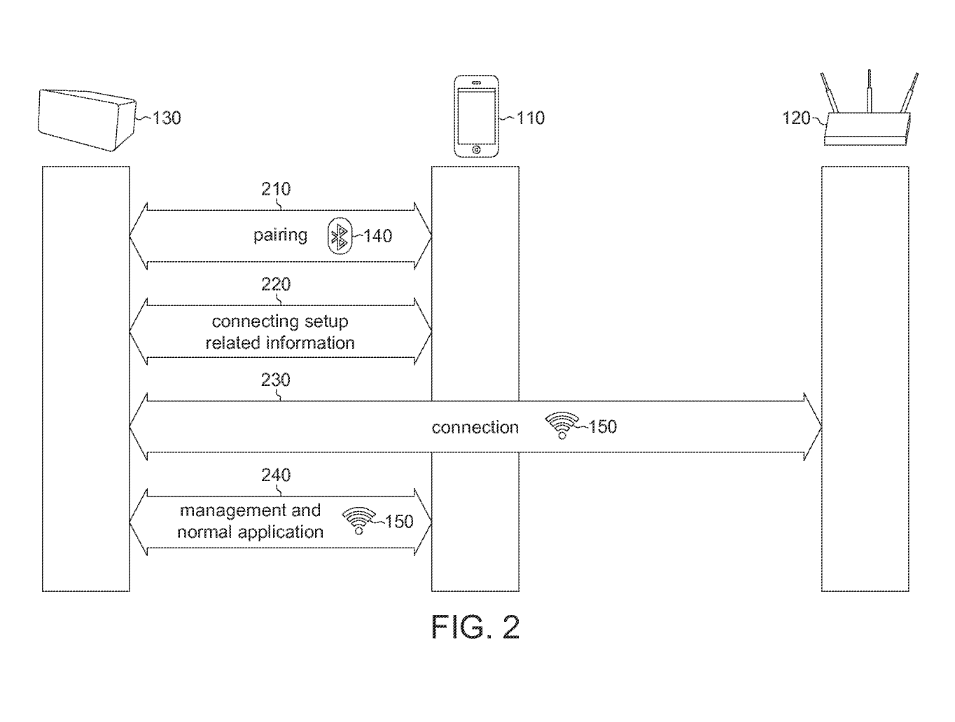

Referring to FIG. 2, a wireless connection setup flowchart for the wireless communication system 100 according to the embodiment of the disclosure is shown. As shown in FIG. 2, in step 210, the smart device 110 and the controlled device 130 are paired via the first wireless communication connection 140 and details of the pairing are omitted here.

In step 220, the smart device 110 sends the connection setup related information to the controlled device 130 via the first wireless communication connection 140. As described above, the connection setup related information includes, for example, an account and a password. The controlled device 130 is connected to the wireless network connecting device 120 and the second wireless communication connection 150 according to the connection setup related information.

In the embodiment, for the smart device 110 and the controlled device 130 to complete the step 220, two applications are installed in the smart device 110 and the controlled device 130, respectively. The application installed in the smart device 110 and the application installed in the controlled device 130 are in one set but different. The two applications in one set refers to that, after the smart device 110 and the controlled device 130 executes the two applications, respectively, the smart device 110 and the controlled device 130 have a relationship similar to a master-slave relationship. The connection setup related information is prepared by the application installed in the smart device 110, and the application installed in the controlled device 130 will convert the received connection setup related information. The application suitable for the smart device 110 is, for example, downloaded from Internet and installed in the smart device 110, and may be updated if necessary. The application suitable for the controlled device 130 may be stored in a storage unit of the controlled device 130 and may be updated if necessary.

Further, in the embodiment, after pairing (step 210), the controlled device 130 sends a device related information (for example, the device name of the controlled device 130) to the smart device 110. The application installed in the smart device 110 can analyze the device related information to judge whether the smart device 110 is able to control the paired controlled device 130 and whether the paired controlled device 130 needs the assistance (i.e. the connection setup related information) from the smart device 110 to be connected to the second wireless communication connection 150 and the wireless network connecting device 120. If yes, the following steps 220˜240 are performed.

Before step 230, the first wireless communication connection 140 between the smart device 110 and the controlled device 130 can be interrupted. Therefore, the smart device 110 and the controlled device 130 are disconnected from the first wireless communication connection 140 for power saving.

In step 230, based on the connection setup related information, the controlled device 130 is connected to the wireless network connecting device 120 and the second wireless communication connection 150. The smart device 110 can identify that the controlled device 130 is already connected to the second wireless communication connection 150. For example, the smart device 110 identifies that the controlled device 130 is already connected to the second wireless communication connection 150 based on an IP address of the controlled device 130.

In step 240, the smart device 110 performs management (for example, setup) and normal application on the controlled device 130 via the second wireless communication connection 150. The normal application includes, for example, that the smart device 110 requests the controlled device 130 and the controlled device 130 provides the requested service to the smart device 110.

For example, if the controlled device 130 is an Internet speaker, the smart device 110 sends audio data to the controlled device 130 via the second wireless communication connection 150, so that the controlled device 130 plays the audio data. By doing so, the user may have better aural enjoyment. Or, if the controlled device 130 is an Internet printer, the smart device 110 sends data to the controlled device 130 via the second wireless communication connection 150, so that the controlled device 130 prints out the data.

Further, after the controlled device 130 is connected to the second wireless communication connection 150, the connection between the smart device 110 and the controlled device 130 may be a peer-to-peer connection, so that the smart device 110 and the controlled device 130 may transmits high bandwidth data to each other. For example, when the peer-to-peer connection between the smart device 110 and the controlled device 130 is implemented by the Intel WiDi connection (which is one example of the second wireless communication connection 150) and the controlled device 130 is a display apparatus supporting network connection, the smart device 110 sends high resolution video data (which consumes high bandwidth) to the controlled device 130. By doing so, the user may watch high resolution video data on the controlled device 130 having large size display screen, and the user may have better watching enjoyment.

As described above, in the embodiment of the disclosure, after the user executes the application installed in the smart device 110 for controlling the controlled device 130, the smart device 110 transmits the connection setup related information to the controlled device 130 and the controlled device 130 is connected to the second wireless communication connection 150 and wireless network connecting device 120. Therefore, the user does not have to input complicated setup information and the manual connection setup procedure is simplified. Besides, the security is maintained in the embodiment of the disclosure because the controlled device 130 still needs the account and the password to be connected to the second wireless communication connection 150 and wireless network connecting device 120.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A wireless communication system, comprising:
a smart device, supporting at least a first wireless communication connection and a second wireless communication connection;
a wireless network connecting device, supporting at least the second wireless communication connection; and
a controlled device, supporting at least the first wireless communication connection and the second wireless communication connection, the controlled device having input keys whose number is less than a threshold value;
wherein
after the smart device and the controlled device are paired via the first wireless communication connection, the smart device sends a connection setup related information to the controlled device via the first wireless communication connection; and
the controlled device is connected to the wireless network connecting device and the second wireless communication connection based on the connection setup related information.

2. The wireless communication system according to claim 1, wherein
the connection setup related information includes an account and a password.

3. The wireless communication system according to claim 1, wherein
the wireless network connecting device selectively supports the first wireless communication connection.

4. The wireless communication system according to claim 1, wherein
a first application installed in the smart device prepares the connection setup related information and a second application installed in the controlled device converts the received connection setup related information.

5. The wireless communication system according to claim 1, wherein
after pairing, the controlled device transmits a device related information to the smart device; and
the smart device analyzes the device related information to judge whether the smart device is able to control the controlled device and whether the controlled device needs the connection setup related information from the smart device to be connected to the second wireless communication connection and the wireless network connecting device.

6. The wireless communication system according to claim 1, wherein
after the controlled device is connected to the second wireless communication connection, the connection between the smart device and the controlled device is a peer-to-peer connection.

7. A setup method for a wireless communication system including a smart device, a wireless network connecting device and a controlled device having input keys whose number is less than a threshold value, the setup method comprising:
pairing the smart device and the controlled device via a first wireless communication connection;
sending a connection setup related information by the smart device to the controlled device via the first wireless communication connection; and
connecting the controlled device to the wireless network connecting device and a second wireless communication connection based on the connection setup related information.

8. The setup method for the wireless communication system according to claim 7, wherein
the connection setup related information includes an account and a password.

9. The setup method for the wireless communication system according to claim 7, wherein
the wireless network connecting device selectively supports the first wireless communication connection.

10. The setup method for the wireless communication system according to claim 7, further comprising:
preparing the connection setup related information by a first application installed in the smart device; and
converting the received connection setup related information by a second application installed in the controlled device.

11. The setup method for the wireless communication system according to claim 7, further comprising;
after pairing, transmitting a device related information from the controlled device to the smart device; and
analyzing the device related information to judge whether the smart device is able to control the controlled device and whether the controlled device needs the connection setup related information from the smart device to be connected to the second wireless communication connection and the wireless network connecting device.

12. The setup method for the wireless communication system according to claim 7, further comprising:
after connecting the controlled device to the second wireless communication connection, connecting the smart device and the controlled device by a peer-to-peer connection.
